(19) United States
(12) Patent Application Publication
(10) Pub. No.: US 2019/0375251 A1
(43) Pub. Date: Dec. 12, 2019

(54) TUNED VIBRATION REDUCER FOR TIRES

(71) Applicant: Bridgestone Americas Tire Operations, LLC, Nashville, TN (US)

(72) Inventors: Yousof Azizi, Barberton, OH (US); Robert W. Asper, Wadsworth, OH (US); Brian D. Steenwyk, Uniontown, OH (US)

(21) Appl. No.: 16/463,160

(22) PCT Filed: Dec. 6, 2017
(86) PCT No.: PCT/US17/64922

§ 371 Date: May 22, 2019

Related U.S. Application Data
(60) Provisional application No. 62/432,943, filed on Dec. 12, 2016.

(51) Int. Cl. B60C 19/00; F16F 7/108

(52) U.S. Cl. CPC B60C 19/002; F16F 7/108

(57) ABSTRACT

A toroidal tire structure has a circumferential tread portion, a pair of bead portions, opposite sidewall portions, and a target resonant frequency of vibration. A tuned mass-damper is operatively coupled to the tire structure. The tuned mass-damper has a counteracting resonant frequency of vibration that is predetermined with reference to the target resonant frequency of vibration.

### TECHNICAL FIELD

This technology relates to the suppression of vibration and noise generated in a tire.

### BACKGROUND

A tire rotating on a road surface may vibrate in response to factors including road conditions and operating conditions of the tire. Tire vibrations can cause air pressure fluctuations, due to interactions between tire structure and air medium surrounding the tire, which can propagate through air and generate noise. Vibrations that propagate from the tire through the structure of the vehicle may cause tactile disturbances in the occupant compartment which causes discomfort for the occupant. The vibrations may also cause noise that emanates from vibrating vehicle parts. It may be desirable to attenuate the noise by suppressing the tire vibration.

### SUMMARY

In an example embodiment, a toroidal tire structure comprises a circumferential tread, a pair of beads, and opposite sidewalls. The tire structure has different natural frequencies. A tuned mass-damper system is operatively coupled to the tire structure, and has a counteracting resonant frequency of vibration that is predetermined with reference to a target resonant frequency of the tire structure.

The tuned mass-damper may be configured in distinct portions of elastic material that establish the counteracting resonant frequency of vibration. These may include a spring portion overlying a peripheral surface of the tire structure, and a mass portion overlying the spring portion. An embodiment of the tuned mass-damper may thus include distinct portions of rubber or other elastic material configured as layers of an elastic structure projecting from a peripheral surface of the tire structure.

The distinct portions of the elastic structure may have properties of density and stiffness that are predetermined with reference to the counteracting resonant frequency. The portions of elastic material may thus include a first portion having stiffness that is predetermined with reference to the counteracting resonant frequency, and a second portion having density that is predetermined with reference to the counteracting resonant frequency.

### BRIEF DESCRIPTION OF THE DRAWINGS

FIG. 1 is a schematic cross-sectional view showing an embodiment of a tire equipped with tuned mass-damper for suppressing noise-generating vibrations.

FIG. 2 is a graph showing noise-generating performance characteristics of a tire.

FIG. 3 is a schematic view showing a mode of vibration of a tire.

FIG. 4 is an enlarged view of a tuned mass-damper shown in FIG. 1.

FIG. 5 is an enlarged view similar to FIG. 4, showing a tuned mass-damper in an alternative embodiment.

FIG. 6 also is an enlarged view similar to FIG. 4, showing a tuned mass -damper in another alternative embodiment.

FIG. 7 is a sectional view of a tuned mass-damper in a further alternative embodiment.

### DETAILED DESCRIPTION

The structures illustrated in the drawings include examples of the elements recited in the claims. The illustrated structures thus include examples of how a person of ordinary skill in the art can make and use the claimed invention. These examples are described to meet the enablement and best mode requirements of the patent statute without imposing limitations that are not recited in the claims. One or more of the elements of one embodiment may be used in combination with, or as a substitute for, one or more elements another as needed for any particular implementation of the invention.

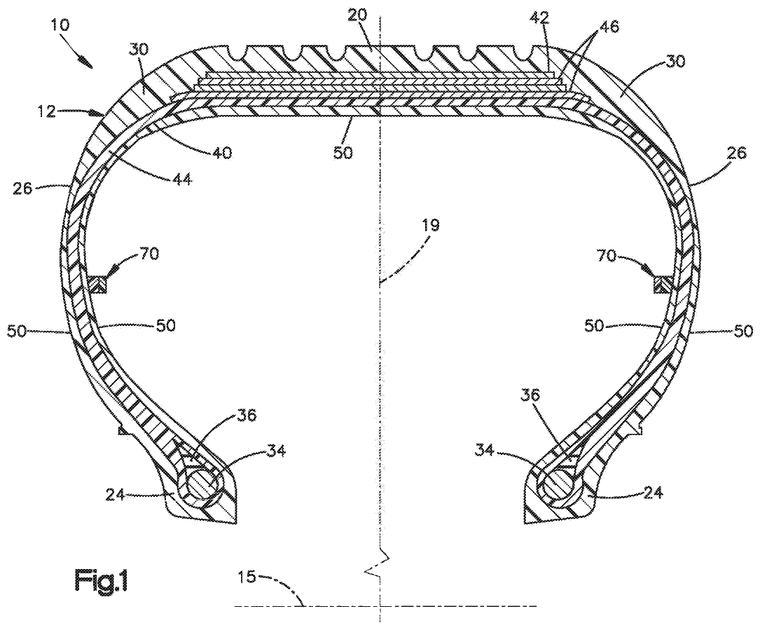

As shown for example in the embodiment of FIG. 1, a tire 10 includes a toroidal tire structure 12 having an axis of rotation 15. The tire structure 12 reaches circumferentially about the axis 15, and is substantially symmetrical about an equatorial plane 19 perpendicular to the axis 15. Major portions of the tire structure 12 include a tread 20, a pair of beads 24, and opposite sidewalls 26.

The tread 20 extends laterally across the equatorial plane 19 between a pair of shoulder portions 30. Each bead 24 includes a bead core 34 and an apex strip 36. Also shown in the embodiment of FIG. 1 is a carcass structure 40 and a belt layer 42. The carcass structure 40 comprises carcass plies 44 of rubber-coated cords that reach radially between and around the beads 24. The belt layer 42 comprises belt plies 46 of rubber-coated cords extending circumferentially over the carcass plies 44. The sidewalls 26 extend over the carcass structure 40 radially from the beads 24 to the shoulder portions 30 of the tread 20. The tread 20, the beads 24, and the sidewalls 26 together provide the tire structure 12 with a continuous peripheral surface 50 of vulcanized rubber.

In use, the tire structure 12 is subjected to broadband dynamic forces from road surface that induce noise-generating vibrations. The applied dynamic forces may vary throughout a range of frequencies. The tire structure 12 may then experience a corresponding range of vibrational modes induced by the applied dynamic forces. Additionally, the range of frequencies may include one or more frequencies at which the tire structure 12 has a resonant vibratory response. The tire structure 12 will then experience a corresponding resonant mode of vibration. Such a resonant mode of vibration may generate excessive noise.

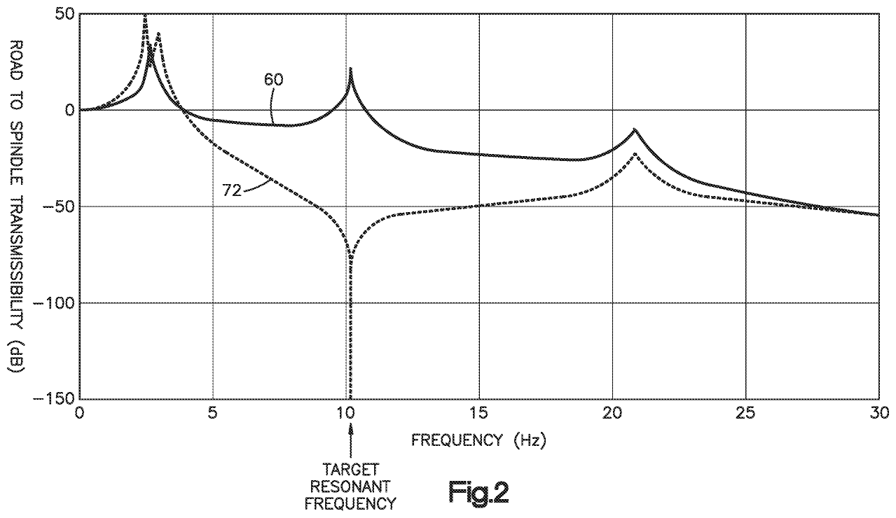

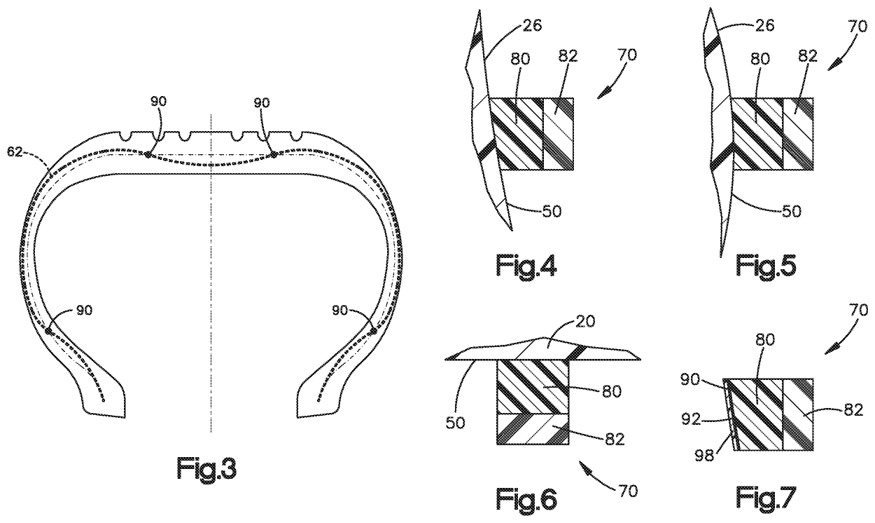

For example, the solid curve 60 in FIG. 2 indicates levels of noise generated by a tire across a range of force input frequencies. The peaks in the curve 60 indicate noise levels generated by resonant vibratory responses in the tire. The peaks in the curve 60 thus occur at resonant frequencies of vibration in the tire. Accordingly, a tire as represented here will vibrate in a resonant mode at each force input frequency corresponding to a peak in the curve 60. Such a resonant mode of vibration is indicated schematically by the dashed line 62 in FIG. 3. In this example, the dashed line 62 represents vibrational displacement of a tire along the centerline of a nominal cross-sectional shape.

The resonant frequencies of noise-generating vibration in the tire structure 12 may be determined in a known manner. One of the determined resonant frequencies may be selected as a target frequency for which the resulting noise is sought to be attenuated. One or more mass-dampers 70 may then be tuned to have a resonant frequency of vibration equal or substantially equal to the target frequency. When a tuned mass-damper 70 is operatively coupled to the tire structure 12, as shown for example in FIG. 1, it can be oriented to vibrate at the target frequency in a resonant mode that acts oppositely to the resonant mode of vibration in the tire structure 12. The counteracting vibrational force inputs from the tuned mass-damper 70 can suppress displacement that might otherwise occur along the dashed line 62 of FIG. 3. This can attenuate the noise generated by vibration at the target frequency, as indicated by the dashed line 72 shown in FIG. 2.

The tire 10 in the embodiment of FIG. 1 is equipped with a pair of tuned mass-dampers 70. In this embodiment the mass-dampers 70 are configured as circumferentially continuous ribs that are oriented oppositely relative to one another at opposed locations inside the sidewalls 26. Each mass-damper 70 has distinct portions of elastic material with properties of density and stiffness that are predetermined with reference to the counteracting resonant frequency. In this example the portions of elastic material include a first portion in which the stiffness is predetermined with reference to the counteracting resonant frequency, and a second portion in which the density is predetermined with reference to the counteracting resonant frequency.

More specifically, the distinct portions of elastic material in the illustrated mass-dampers 70 include an inner layer 80 of rubber, and an outer layer 82 of rubber that overlies and is bonded to the inner layer 80. The inner layer 80 of each mass-damper 70 overlies and is bonded to the peripheral surface 50 at the inside of the respective sidewall 26. Bonding of the layers 80 and 82 together, as well as bonding of the inner layer 80 to the peripheral surface 50, may be accomplished before, during, or after vulcanization of the rubber of which the tire structure 12 is formed.

The inner and outer layers 80 and 82 may have the same stiffness or differing stiffness, but in either case the stiffness of the inner layer 80 is predetermined with reference to the counteracting resonant frequency. The inner and outer layers 80 and 82 may also have the same density or differing density, but in either case the density of the outer layer 82 is predetermined with reference to the counteracting resonant frequency. This enables the inner layer 80 to serve as a spring portion of the mass-damper 70, with the outer layer 82 serving as a mass portion coupled to the spring portion. When a sidewall 26 deflects, the respective mass-damper 70 acts as a spring/mass system to counteract the deflection. These counteracting spring/mass actions of each mass-damper 70 are optimal at the resonant frequency of vibration to which the mass-damper 70 is tuned. Since the mass-dampers 70 are tuned to the target resonant frequency of the tire structure 12, they apply optimal resistance to deflection of the tire structure 12 in the corresponding resonant mode of vibration.

Although the embodiment of FIG. 1 has a pair of mass-dampers 70 at the inside of the sidewalls 26, a tire may be equipped with either a single or multiple mass-dampers 70, and each mass-damper 70 may be located at any other suitable location on the toroidal tire structure 12. Other suitable locations may include the outside of a sidewall 26 as shown in the embodiment of FIG. 5, or the inside of the tread 20 as shown in FIG. 6. However, in each case the location of the mass-damper 70 is preferably selected with reference to the resonant mode of vibration sought to be suppressed. For example, the resonant mode of vibration indicated schematically in FIG. 3 has nodal points 90 at which the amplitude of vibration is zero. The mass-dampers are 70 are mounted at locations spaced from such nodal points, and may be optimally located where the amplitude of vibration is greatest.

Further regarding placement of the mass-dampers 70, the embodiment of FIG. 7 includes a coating 94 of adhesive on a bottom surface 96 of the inner layer 80, which in this configuration is the innermost surface of the mass-damper 70. The coating 94 may comprise any adhesive composition suitable for bonding the mass-damper 70 to a peripheral surface of a tire. A peel-away cover layer 98 may be provided over the adhesive coating 94 for more convenient handling of the mass-damper 70 if used as an aftermarket product.

This written description sets for the best mode of carrying out the invention, and describes the invention so as to enable a person of ordinary skill in the art to make and use the invention, by presenting examples of the elements recited in the claims. The detailed descriptions of those elements do not impose limitations that are not recited in the claims, either literally or under the doctrine of equivalents.

What is claimed is:

1. A tire, comprising:
a toroidal tire structure having a circumferential tread portion, a pair of bead portions, opposite sidewall portions, and a target resonant frequency of vibration; and
a tuned mass-damper operatively coupled to the toroidal tire structure and having a counteracting resonant frequency of vibration that is predetermined with reference to the target resonant frequency of vibration.

2. A tire as defined in claim 1, wherein the counteracting resonant frequency is equal or substantially equal to the target resonant frequency.

3. A tire as defined in claim 1, wherein the tuned mass-damper is configured in distinct portions of elastic material having properties of density and stiffness that are predetermined with reference to the counteracting resonant frequency.

4. A tire as defined in claim 1, wherein the tuned mass-damper is coupled to the toroidal tire structure at one of the opposite sidewall portions.

5. A tire as defined in claim 1, wherein the tuned mass-damper is one of a pair of tuned mass-dampers that are coupled to the toroidal tire structure at the opposite sidewall portions.

6. A tire as defined in claim 1, wherein the tuned mass-damper is coupled to the tire toroidal structure at the tread portion.

7. A tire as defined in claim 1, wherein the tuned mass-damper is coupled to the toroidal tire structure at a peripheral surface of the toroidal tire structure.

8. A tire, comprising:
a toroidal tire structure including a circumferential tread, a pair of beads, a pair of sidewalls, and a peripheral surface encompassing the tread, the beads, and the sidewalls; and
an elastic structure projecting from the peripheral surface of the toroidal tire structure;
wherein the elastic structure has a first portion and a second portion overlying the first portion; and
wherein the first portion has predetermined stiffness and the second portion has predetermined density.

9. A tire as defined in claim 8, wherein the stiffness and density are predetermined to provide the elastic structure with a predetermined resonant frequency of vibration.

10. A tire as defined in claim 8, wherein the first portion of the elastic structure is an innermost portion.

11. A tire as defined in claim 8, wherein the second portion of the elastic structure is an outermost portion.

12. An apparatus for use with a toroidal tire structure having a circumferential tread, a pair of beads, a pair of sidewalls, and a peripheral surface encompassing the tread, the beads, and the sidewalls, the apparatus comprising:
a tuned mass-damper configured for attachment to the peripheral surface of the toroidal tire structure and having a predetermined resonant frequency of vibration.

13. An apparatus as defined in claim 12, wherein the toroidal tire structure has a resonant frequency of vibration, and the resonant frequency of vibration of the tuned mass-damper is predetermined with reference to the resonant frequency of vibration of the toroidal tire structure.

14. An apparatus as defined in claim 12, wherein the tuned mass-damper is configured in distinct portions of elastic material having properties of density and stiffness that are predetermined with reference to the resonant frequency of vibration.

15. An apparatus as defined in claim 12, wherein the tuned mass-damper has an innermost surface configured to overlie the peripheral surface of the toroidal tire structure, and further comprising an adhesive coating on the innermost surface.
